(19) United States
(12) Patent Application Publication
(10) Pub. No.: US 2006/0259356 A1
(43) Pub. Date: Nov. 16, 2006

(54) Adpost: a centralized advertisement platform

(75) Inventors: Benyu Zhang, Beijing (CN); Fengping Zeng, Beijing (CN); Hua-Jun Zeng, Beijing (CN); Li Li, Issaquah, WA (US); Wei-Ying Ma, Beijing (CN); Ying Li, Bellevue, WA (US); Zheng Chen, Beijing (CN); Tarek Najm, Kirkland, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/127,130

(22) Filed: May 12, 2005

(51) Int. Cl. G06Q 30/00

(52) U.S. Cl. 705/14

(57) ABSTRACT

A method is provided to ubiquitously promote products or services provided by a plurality of advertisers across a plurality of content-based applications. The method may include receiving data from the plurality of advertisers describing the products or services provided by the plurality of advertisers. The received data is stored in an advertisement database where a user may subsequently query the advertisement database to locate data promoting a product or service. Additionally, terms and payment data are extracted from the received advertisement data to efficiently promote the products or services provided by the advertiser across the plurality of content-based applications.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

Embodiments of the present invention relate generally to advertising products or services provided by advertisers on the Internet. Specifically, the present invention provides a system and method to automatically derive keywords for the products or services provided by the advertisers.

### BACKGROUND OF THE INVENTION

Currently, advertisers promoting products or services advertisements may chose from conventional or Internet mediums. Many large advertisers rely on the conventional mediums, e.g., newspaper, radio or television, to promote the products or services advertisements because the large advertisers retain complete control over where and how the products or services advertisements are displayed. Smaller advertisers rely on the Internet mediums, e.g., websites or portals, to promote the products or services advertisements because the Internet mediums provide scale and distribution at low cost. Accordingly, advertisers using the Internet mediums have the ability to promote the products or services advertisements on a global scale whereas the conventional mediums provide the ability to promote on a local or national scale.

Internet advertising tools, such as for example, Microsoft Moonshot, EBAY, Blogs, and Bulletin Board Systems (BBS), provide interfaces to receive the products or services advertisements. For instance, Microsoft Moonshot allows the advertisers having websites that promote the products or services advertisements to pay for terms that are associated with the products or services advertisements. So, when a user enters the terms in an Internet search tool, e.g., Microsoft's MSN search, the websites that promote the products or services advertisements are returned to the user in addition to normal search results.

EBAY, Blogs and BBS provide alternate Internet advertising tools to promote the products or services advertisements. However, each alternative lacks the ability to automatically determine whether the products or services advertisements are legitimate without endangering a group of consumers to fraudulent products or services advertisements. Moreover, an advertiser that fails to maintain a website that promotes the advertiser's products or services cannot efficiently utilize the current Internet advertising tools.

Therefore, a need arises to provide new advertising tools to enable advertisers that fail to maintain Internet mediums promoting the products or services provided by the advertisers to efficiently utilize the Internet when promoting the products or services provided by the advertisers.

### SUMMARY OF THE INVENTION

These and other problems, in the art, are solved by an advertising tool that implements a method to enable advertisers that do not maintain Internet mediums that describe products or services provided by the advertisers to ubiquitously promote the products or services across a plurality of content-based applications.

The method to ubiquitously promote the products or services includes receiving data from the advertisers describing the products or services. The method also includes extracting terms and payment data from the data received from the advertisers. The advertising tool promotes the products or services across the plurality of content-based applications based on the extracted terms and payment data.

The data received from the advertisers is stored in a database to allow users to enter search terms in the advertising tool to locate the data describing the products or services. The users' searches, including search terms, that are sent to the advertising tool and the data received from the advertisers are logged in a log file to provide reports illustrating database utilization and conversion rates for the products or services promoted by the advertising tool.

The advertising tool includes an advertisement submission component where the advertisers enter the data describing the products or services. The advertising tool includes a query advertisement component where the users may enter the search terms to query the database. Additionally, the advertising tool includes a report component to generate the reports based on data in the log file. Accordingly, the advertising tool enables the advertisers to forego burdens associated with maintaining Internet mediums while allowing the advertisers to efficiently promote products or services across the Internet.

Additional advantages and novel features will be set forth in the description which follows and in part may become apparent to those skilled in the art upon examination of the following or may be learned by practice of the invention.

### BRIEF DESCRIPTION OF THE DRAWINGS

FIG. 1 illustrates a block diagram of a computing environment adapted to implement the present invention;

FIG. 2 illustrates a user interface for an advertising tool utilized by embodiments of the present invention;

FIG. 3 illustrates an advertisement submission user interface, utilized by embodiments of the present invention, where advertisers describe products or services provided by the advertisers;

FIG. 4 illustrates a search advertisement database user interface, utilized by embodiments of the present invention, where a user can locate data describing the products or services provided by the advertisers;

FIG. 5 illustrates an advertisement reports user interface, utilized by embodiments of the present invention, which provides reports on conversion rates and database utilization;

FIG. 6 illustrates an overview of a network environment implementing embodiments of the present invention;

FIG. 7 illustrates an architecture of a centralized advertisement platform implementing the advertising tool utilized by embodiments of the present invention;

FIG. 8 illustrates a log analysis flow diagram utilized to analyze log files generated by the present invention; and

FIG. 9 illustrates a flow diagram, utilized by embodiments of the present invention, which implements a method to promote products or services provided by the advertisers.

### DETAILED DESCRIPTION

Embodiments of the present invention provide an advertising tool to promote products or services provided by a plurality of advertisers. The advertising tool is a centralized advertisement platform where the plurality of advertisers can submit data describing the products or services provided by the advertisers. The data may include information on different type of advertisements, such as, for example, personal, auction and job advertisements. The advertising tool generates reports to inform the plurality of advertisers how the different types of advertisements are performing.

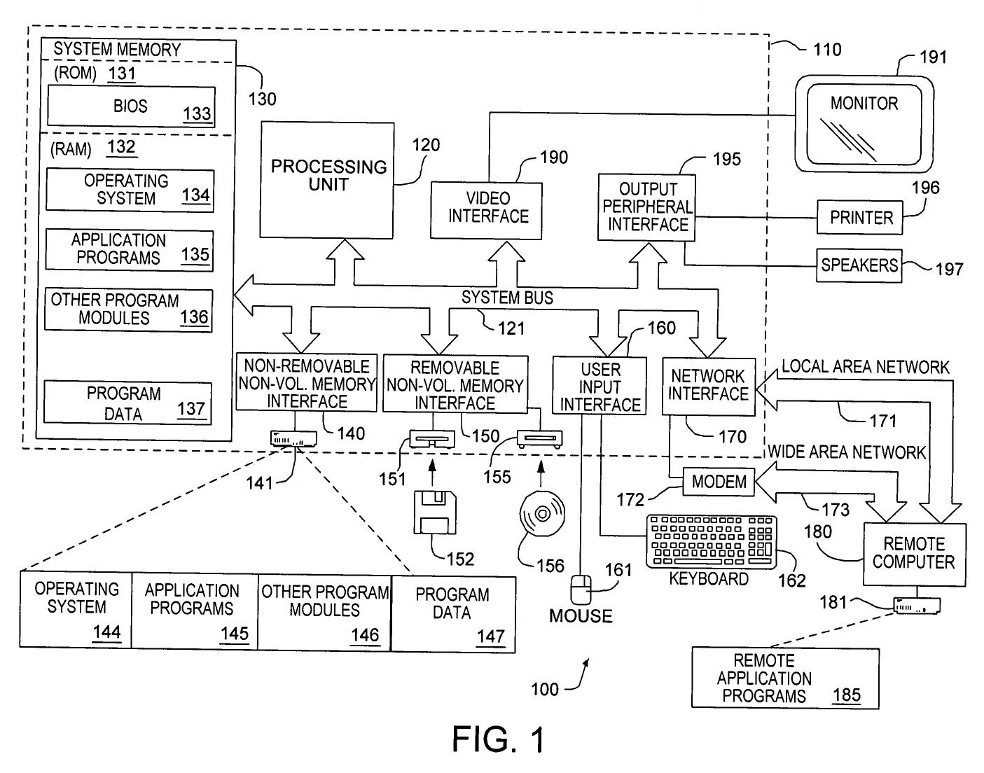

FIG. 1 is a block diagram that illustrates a computing environment adapted to implement the present invention. The computing system environment 100 is only one example of a suitable computing environment and is not intended to suggest any limitation as to the scope of use or functionality. Neither should the computing environment 100 be interpreted as having any dependency or requirement relating to any one or combination of components illustrated in the exemplary operating environment 100.

The present invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The present invention may be described in the general context of computer-executable instructions, such as program modules, being executed by a computer. Generally, program modules include routines, programs, objects, components, data structures, etc. that perform particular tasks or implement particular abstract data types. The present invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the present invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect Express (PCI Express) and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The wireless communication media may be networks such as for example, Bluetooth or 802.11 networks. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the processing unit 120 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks, such as wireless networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

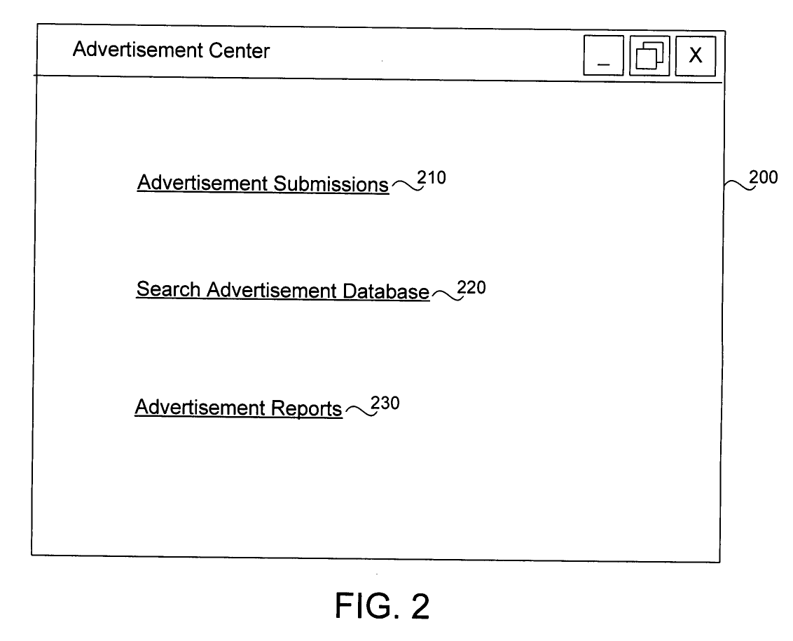

FIG. 2 illustrates a user interface 200 for an advertising tool utilized by embodiments of the present invention. The user interface 200 includes references to acts that users or advertisers may perform when utilizing the advertising tool. The acts may include advertisement submissions, searching an advertisement database and retrieving advertisement reports. The advertising tool may include an advertisement submission reference 210 that generates an advertisement submission user interface, a search advertisement reference 220 that generates a search advertisement database user interface and an advertisement reports reference 230 that generates an advertisement report interface.

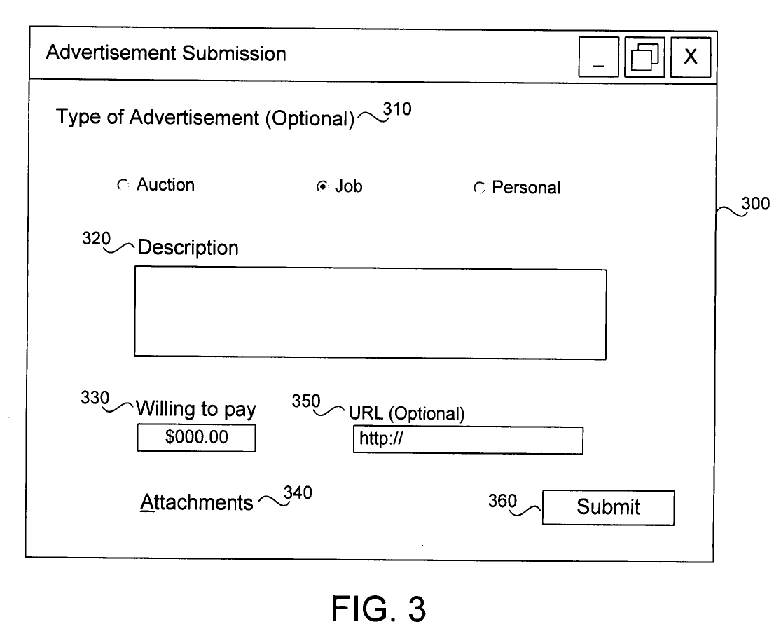

FIG. 3 illustrates the advertisement submission user interface 300, utilized by embodiments of the present invention, where the advertisers describe products or services provided by the advertisers. The advertisement submission user interface 300 may include, but is not limited to, an optional type of advertisement radio button 310, a description field 320, a willing to pay field 330, an optional uniform resource locator (URL) field 350, an attachments reference 340 and a submit button 360.

The type of advertisement radio button 310, an optional element, includes auction, job, and personal advertisements. Here, the advertisers may specify whether the products or services, provided by the advertisers, are jobs, auction, or personal—mate seeking or partner seeking. In an alternate embodiment of the present invention, if the user does not specify the type of advertisement, the advertising tool automatically categorizes data received from the advertisers describing of the products or services.

The description field 320 allows advertisers to enter data describing the products or services provided by the advertisers. The data includes textual information, including cost or quantity data. In conjunction with the description field 320 the advertiser may also use the attachments reference 340 to include multimedia content, audio or video to the data describing the products. In an embodiment of the present invention, the advertising tool may bar the advertisers from submitting a submission that does not include data from either the description field 320 or attachment reference 340.

The willing to pay field 330 allows the advertisers to specify a monetary amount the advertisers pay to have the products or services promoted using the advertising tool.

The URL field 350 is an optional field that allows the advertisers that have a homepage to specify the URL for the homepage.

The submit button 360 allows the advertisers to submit the data describing the products or services to a database storing the data provided by the advertisers.

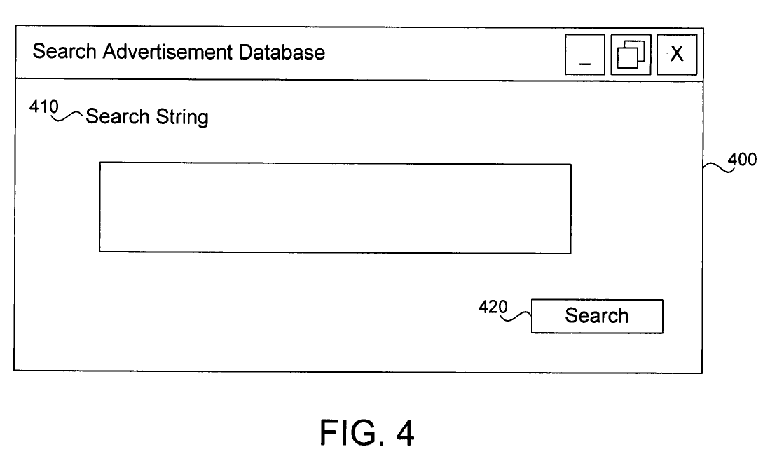

FIG. 4 illustrates a search advertisement database user interface 400, utilized by embodiments of the present invention, where a user can locate data stored in the database describing the products or services provided by the advertisers. The search advertisement database user interface 400 includes a search string field 410 and a search button 420.

The search string field 410 allows the user to enter terms that relate to a product or service that the user is seeking.

The search button 420 submits the terms entered by the user to the database and search results are returned to the user. The database may also receive queries from a mining engine that automatically generate queries related to the user's search. In an embodiment the related queries expand the user search terms. The expansion of the user terms may include mining terms from other applications on the system. For instance, if the user is utilizing a media player or a instant messenger chat session, the mining engine may mine the media being reproduced on the media player to generate additional search terms or may mine the chat session to generate additional search terms. The additional search terms may be submitted simultaneously with the search entered by the user.

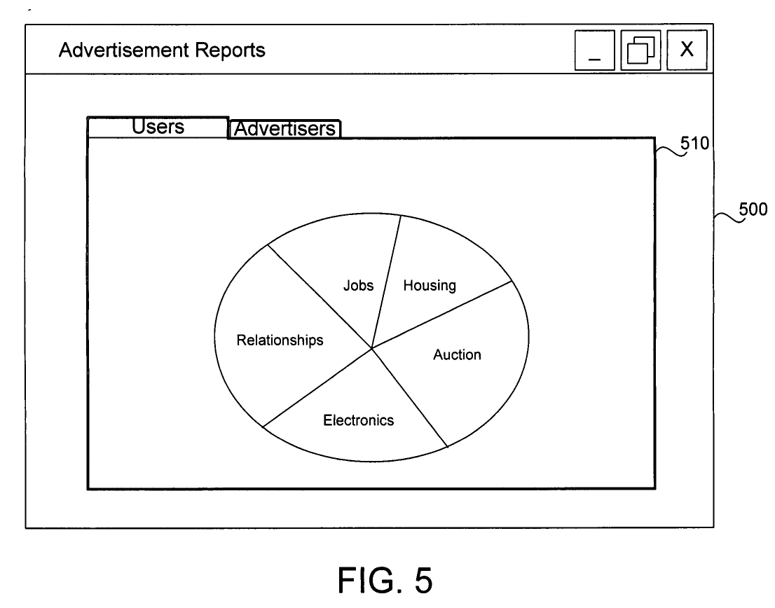

FIG. 5 illustrates an advertisement reports user interface 500, utilized by embodiments of the present invention, which provides reports on conversion rates and database utilization. The reports user interface 500 includes a reports tab control element 510 that includes a tab for each available report.

The reports tab control element 510 may include reports that illustrate the database utilization based on user queries. For instance, a utilization report may show what percentage of the population of users are interested in products or services related to jobs, housing, auctions, electronics and relationships. The advertising tool may utilize the information provided by the reports tab control element 510 to properly promote advertisements that a majority of the population cares about.

The reports tab control element 510 may also include reports that provide the conversion rates for each advertiser to determine how the advertisers are doing, comparatively. The metric may specify which advertisers have a better chance of receiving a sale after an advertisement, related to a product or service provided by the advertisers, is viewed or clicked on by a user.

The advertising tool is a centralized advertising platform that receives data related to different types of advertisements for products or services provided by the advertisers. The advertising tool efficiently promotes the advertisements and generates reports to illustrate the effectiveness of the advertisement data provided by the advertisers. In an embodiment of the present invention, the advertising tool may automatically supplement the data received from the advertiser with other advertisement data if it is determined that the other advertisement data enhances the received advertising data.

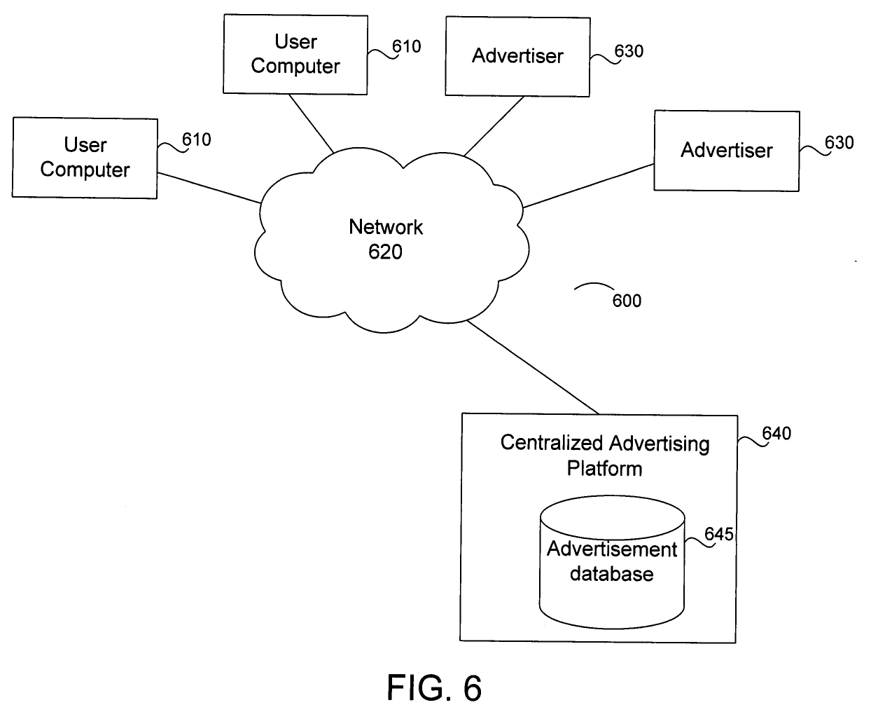

FIG. 6 illustrates an overview of a network environment 600 implementing embodiments of the present invention. The network environment 600 includes users 610, advertisers 630, a network 620 and a centralized advertising platform 640 having an advertisement database 645.

The user computers 610 are terminals where users may access the centralized advertisement platform 640 through the network 620. The user computers submit user queries to the advertising database 645 to retrieve data stored in the advertisement database.

The advertisers 630 submit data describing products or service provided by the advertisers through network 620 to the centralized advertising platform 640. The data submitted by the advertiser 630 is stored in the advertisement database 645.

The centralized advertising platform 640 includes the advertising database 645. The advertisement database 645 stores data, submitted by the advertisers, which describes a plurality of different types of advertisements, such as, for example, auction, personal and job advertisements.

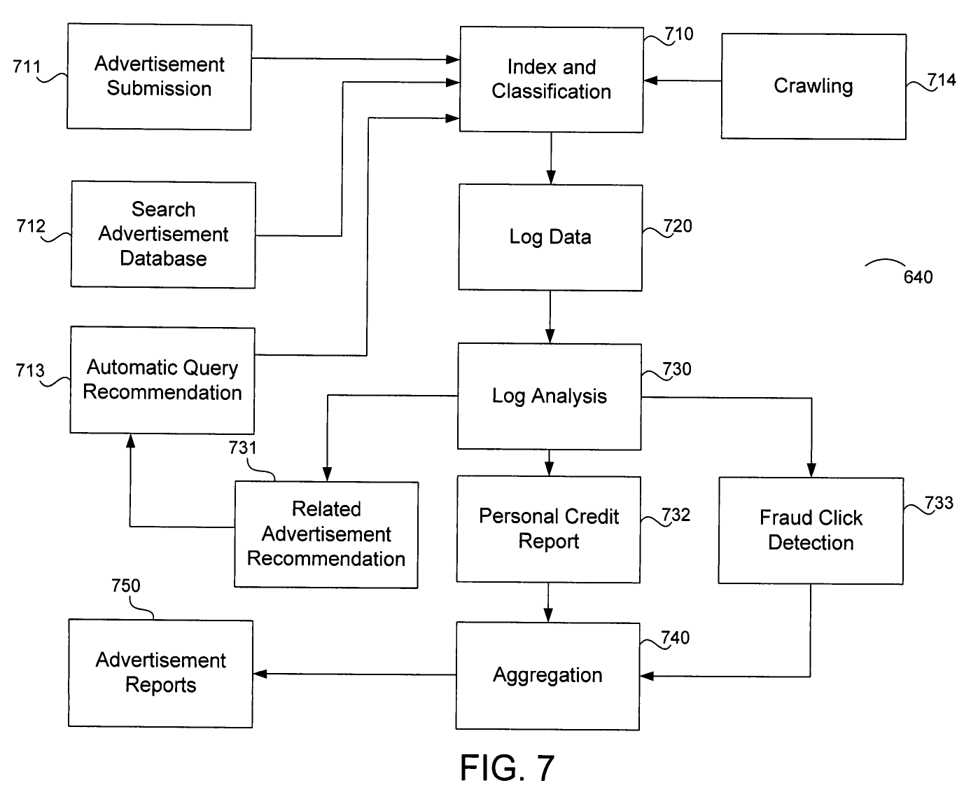

FIG. 7 illustrates an architecture of a centralized advertisement platform implementing the advertising tool utilized by embodiments of the present invention. The centralized advertising platform 640 utilizes front-end and back-end components to implement the functionality of the advertising tool. The front-end components include advertisement submission component 711, search advertisement database component 712, automatic query recommendation component 713 and advertisement reports component 750, which were discussed with reference to FIGS. 2-5 above. The back-end components include an index and classification component 710, a crawling component 714, a log data component 720, a log analysis component 730, a fraud-click detection component 733, a personal credit component 732, a related advertisement recommendation component 731 and an aggregation component 740.

The index and classification component 710 is part of the advertisement database 645. The index and classification component 710 receives data from front-components 711-713. The index and classification component may also receive data from the crawling component 714. The index and classification component 710 utilizes the information received from front component 711 and back-end component 714 to generate an index data structure that enables the system to query the data stored in the advertisement database 645.

The crawling component 714 is utilized when certain types of advertisers have very minute amounts of data in the advertisement database 645 or when the advertisement database 645 is initially sparse. When the advertisers have little data about the products or services, the crawling component 714 may be triggered to gather additionally information about the products or services provided by the advertisers. Additionally, when the advertisement database 645 is sparse with regard to all types of advertisements, the crawling component 714 collects advertising data about all types of advertisements from locations, e.g., websites, having data related to the sparse advertisements. For instance, if the advertising database 645 is sparse on job advertisements, the crawling component 714 will crawl locations having advertisements related to job advertisements. However, if the advertisement database 645 is sparse with regard to all types of advertisements, such as, for example, job, auction, and personal advertisements, the crawling component will crawl locations having data describing products or services related to all types of advertisements stored in the advertisement database 645. In an embodiment of the present invention, the crawling component 714 may allow advertiser that have not paid for promoting the products or services to have a temporary free promotional period on the advertising tool.

The log data component 720 automatically logs the data received from front-end components 711 and 712 and creates a log file. The data submitted by the advertisers and users is logged by the log data component 720 and stored in the log file. The log data may include data, such as, for example, Internet protocol (IP) addresses, timestamps, user identification and if a sale is made, the data may also include transaction related information, such as, for example cost and quantity. In an alternate embodiment of the present invention, the log data may include data received from the crawling component 714, such as, for example, a URL and advertiser name for locations visited by the crawling component 714.

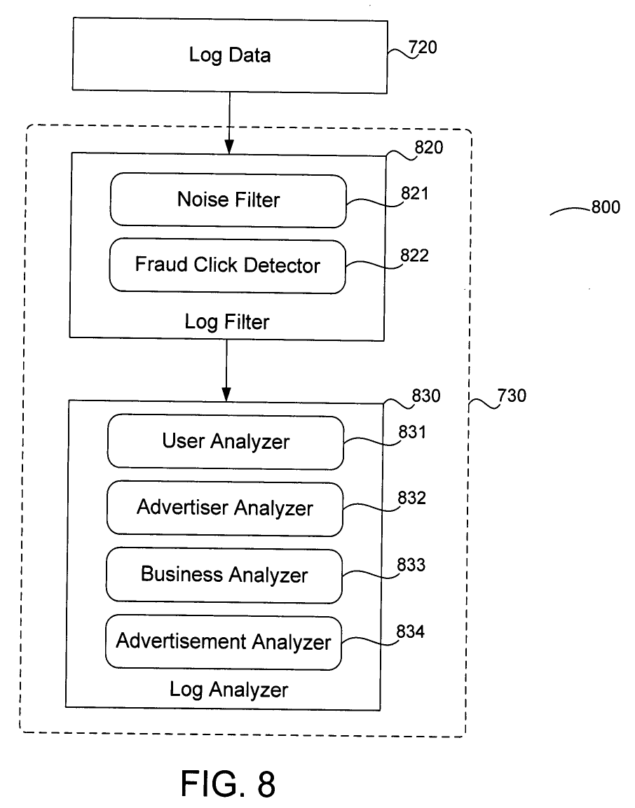

The log analysis component 730 analyzes the log data stored by the log data component 720. A further description of the log analysis component 730 can be found when referencing FIG. 8.

The advertisement recommendation component 731 utilizes data received from the log analysis component 730 to generate recommendations on related queries. The recommendations may be related to a user query submitted to the front-end component 712 or the recommendation may be related to contextual data. The contextual data may include data generated in a chat session, data reproduced by a multimedia, audio or video player, or data in a word processor. The recommendation component 731 sends the query to front-end component 713, where the query is submitted to the advertisement database 645.

The personal credit report component 732 utilizes data received from the log analysis component 730 to calculate a credit worthiness of a user or advertiser when a transaction involving the user to advertiser has occurred.

The fraud click detection component 733 utilizes the data received from the log analysis component 730 to prevent fraudulent transactions. A detailed description of the fraud click detection component is provided in a previous patent application entitled System and Method for Automatic Detection of Distributed Paid Advertisement Attack (MS Docket No. 309271.01), application Ser. No. 10/998,658 (MFCP.115016), filed on Nov. 30, 2004.

The aggregation component 740 receives a large amount of data from the personal credit component 732 and the fraud click detection component 733 and generates reports, which detail user interests and advertisers' performances. The aggregation component 740 consolidates the large amount of data received from the personal credit component 732 and the fraud click detection component 733 to generalize the large amount of data, change the granularity of the data from high level to low level of granularity, and present an overview of a utilization of the advertisement database 645. The generalized data and overview are sent to the front-end component 750.

FIG. 8 illustrates a log analysis flow diagram 800 utilized to analyze log data 720 generated by the present invention. With reference to FIGS. 7 and 8, the log analysis component 730 implements the operations discussed below after storing data logged from the front-end components 711-714 in the log data component 720. The log analysis component 730 includes a log filter 820 and a log analyzer 730.

The log filter 820 includes a noise filter 821 and a fraud click detector 822. The log filter 820 receives data having high granularity and reduces the granularity of the data to provide data having valuable information over a period of time, such as example, data, month, year, and lifetime. For instance, the noise filter 820 may reduce the granularity of the data by determining a piece of the data is static over a specified period of time and retaining one reference to the static data and removing subsequent reference to the static data.

A history of a product or service provided by an advertiser may be generated utilizing the log data component 720, and the fraud click detector 822 may analyze the history to determine if the advertiser is attempting to defraud the advertising tool. A simple method to defraud the advertising tool would be to generate a script to continuously retrieve information about the product or service provided by the advertiser. The simple method to defraud may be modified to allow multiple computers to reference the information about the product or service of the advertiser. In an embodiment of the present invention, the fraud click detector 822 determines whether an advertiser is attempting to utilize either of the simple or modified method to defraud the advertising tool.

The log filter 820 sends the log data having the reduced level of granularity to the log analyzer 830. The log analyzer 830 includes a user analyzer 831, an advertiser analyzer 832, a business analyzer 833 and an advertisement analyzer 834. The analyzers utilize the log data having the reduced level of granularity and business rules to determine market share, utilization of advertisement database 645, user or advertiser legitimacy and conversation rates.

The user analyzer 831 includes business rules to determine user legitimacy. The user analyzer 831 may analyze the log data having reduced granularity and determine that the user is not real or that the user is fraudulently representing another individual by using the individual's identity. For instance, the user analyzer 831 may determine that a user's transactional behavior has dramatically changed, from purchasing products or services having small monetary value to items having large monetary value. Additionally, the user analyzer 831 may determine that the user has generated a large amount of log data, which may be an indication that the user is an agent or script.

The advertiser analyzer 832 determines the legitimacy of an advertiser. The advertiser analyzer utilizes business rules to determine whether an advertiser is fraudulent. The analysis of the log data having reduced granularity may indicate that an advertiser has defrauded the advertising tool. The advertiser analyzer 832 may decide that the advertiser does not exist based on information received from the credit report received when processing payment data. Accordingly, the advertising tool denies access and does not promote products or services from the advertiser that attempts to defraud the advertising tool.

The business analyzer 833 may determine the conversion rates of the products or services promoted by the advertising tool. The business analyzer 833 determines whether an advertiser is paid per click or per transaction. When the advertiser is paid per transaction, the advertising tool does not allow the advertiser to post contact information for the advertiser when describing the products or services provided by the advertiser. However, if the advertiser is paid per click, personal contact information is allowed.

Here, when a user clicks on an advertisement and initiates a transaction, the business analyzer 833 determines that the user has been converted from a browser or visitor to a purchaser. The log data having reduced granularity and business rules measuring conversion are utilized to determine the conversion rates for advertisers promoting products and services on the advertising tool. In an embodiment of the present invention, terms describing products or services that lead to conversion are stored by the advertising tool and may automatically be associated with the products or services of advertisers paying the most when promoting the products or services on the advertising tool.

The advertisement analyzer 834 determines the utilization of the advertisement database 645, and market share for different types of products or services promoted by the advertising tool. The advertisement analyzer 834 may determine the utilization of the advertisement database 645 based on the types of advertisement stored in the advertisement database 645. The advertisement analyzer 834 may determine utilization by a percentage of disk space, queries, or entries for each type of advertisement stored in the advertising database. Furthermore, the advertisement analyzer 834 determines the market share for the different types of products or services based on the percentage of total sales transacted for each type of product or service promoted on the advertising tool. The advertisement analyzer 834 may utilize the market share or advertising database utilization information to determine which products of services need more or better promotions. If the market share or utilization for a particular product or service is below a specified threshold, the advertising tool adjusts to promote the particular service or product.

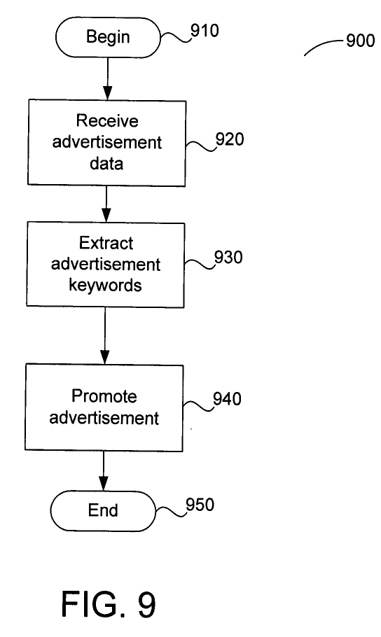

FIG. 9 illustrates a flow diagram, utilized by embodiments of the present invention, which implements a method to promote products or services provided by the advertisers.

The method begins in step 910 when the advertisers initiate the advertising tool. The advertisers provide advertisement data that describes the products or services provided by the advertiser to the advertising tool in step 920. The advertiser may not know what keywords best describe the product. The advertising tool automatically extracts keywords from the advertisement data in step 930. The advertising tool ubiquitously promotes the advertisement data across content-based applications, including word processors, multimedia players, web browsers and instant messenger sessions in step 940. The process ends in step 950.

In sum, a centralized advertisement platform relieves advertisers from the burden of maintaining a homepage and enables the advertisers to promote different types of advertisements ubiquitously to a plurality of content-based applications. The centralized advertisement platform automatically extracts terms and payment data to efficiently promote the different types of advertisements. Additionally, the centralized advertisement platform provides reports on advertisement conversions rates and legitimacy. The foregoing descriptions of the invention are illustrative, and modifications in configuration and implementation will occur to persons skilled in the art. For instance, while the present invention has generally been described with relation to FIGS. 1-9, those descriptions are exemplary. Accordingly, the scope of the invention is to be limited only by the following claims.

We claim:

1. A method to promote products or services provided by a plurality of advertisers, the method comprising:
receiving data from the plurality of advertisers describing the products or services provided by the plurality of advertisers;
extracting payment data from the data received from the plurality of advertisers; and
promoting the products or services based on the payment data.

2. The method according to claim 1, further comprising:
automatically deriving terms that correspond to the products or services provided by the plurality of advertisers.

3. The method according to claim 1, wherein the data describing the products or services includes multimedia content.

4. The method according to claim 1, wherein the data describing the products or services does not include a homepage.

5. The method according to claim 1, wherein the payment data specifies an amount the plurality of advertisers are willing to pay when promoting the products or services provided by the plurality of advertisers.

6. The method according to claim 5, wherein the payment data also specifies whether the plurality of advertisers are paid per click or per transaction.

7. A computer-readable medium having computer-executable components executing instructions to perform the method of claim 1.

8. A method to promote a plurality of different types of advertisements, the method comprising:
crawling a plurality of locations having different types of advertisements to generate an advertisement database;
receiving advertising data, corresponding to different types of advertisements, from advertisers not in the advertisement database;
storing the received advertising data in the advertisement database; and
generating reports to illustrate conversion rates for the different types of advertisements stored in the advertisement database.

9. The method according to claim 8, wherein the different types of advertisements include job, personal and auction advertisements.

10. The method according to claim 8, further comprising:
promoting the advertisements, stored in the advertisement database, on content-based applications.

11. The method according to claim 10, wherein the content-based applications include messenger services, multimedia players, text editors and web browsers.

12. The method according to claim 8, further comprising:
receiving a user query to search the advertisement database.

13. The method according to claim 12, wherein a second query related to the user query is generated on the fly, and the user query and the second query are sent to the advertisement database simultaneously.

14. A computer-readable medium having computer-executable components executing instructions to perform the method of claim 8.

15. A system for a centralized advertising platform, the system comprising:
an advertisement submission component to receive advertisement data;
a query advertisement component to query an advertisement database storing the received advertisement data; and
a report component to generate reports that illustrate a utilization for the advertisement database or legitimacy of advertisers or users.

16. The system according to claim 15, further comprising:
a log analysis component to collect and aggregate log data corresponding to the advertisement data stored in the advertisement database.

17. The system of claim 16, wherein the log analysis component includes a noise filter to remove static data.

18. The system according to claim 16, wherein the reports utilize the aggregated log data, which is aggregated based on whether advertisers receive payments per transaction or per click.

19. The system according to claim 17, wherein reports for advertisers receiving per transaction payments provide aggregate log data having a low level of granularity.

20. The system of claim 17, wherein reports for advertisers receiving per click payments provide aggregate log data having a high level of granularity.
